(19) United States
(12) Patent Application Publication
(10) Pub. No.: US 2004/0090497 A1
(43) Pub. Date: May 13, 2004

(54) Acoustic ink printer

(75) Inventors: Philip J. Entingh, Ontario, NY (US); Roger Leighton, Rochester, NY (US); Peter J. Nystrom, Webster, NY (US)

Correspondence Address: Janik Marcovici, PERMAN & GREEN, LLP, 425 Post Road, Fairfield, CT, 06824, US

(73) Assignee: Xerox Corporation

(21) Appl. No.: 10/293,133

(22) Filed: Nov. 13, 2002

(51) Int. Cl. B41J 2/05

(52) U.S. Cl. 347/65

(57) ABSTRACT

An ink printing acoustic print head. The ink printing acoustic print head prints ink on a print medium. The ink printing acoustic print head has a fluid distribution manifold and a fluid distribution stack in fluid communication with the fluid distribution manifold. A front membrane has a print work area. The front membrane is sealed to the fluid distribution stack. An acoustic array having droplet emitters is fixedly located between the front membrane and the fluid distribution stack with the droplet emitters facing the print work area. Ink is transferred from the fluid distribution manifold through the fluid distribution stack and to the print work area. Droplets of ink are emitted from the print work area by selectively energizing the droplet emitters.

### BACKGROUND OF THE INVENTION

The present invention relates to an acoustic ink printer and, more particularly, to an acoustic ink printer print head.

AIP (Acoustic Ink Printing) is a method for transferring ink directly or via intermediate means such as a transfer belt, drum, or roll, to a recording medium with several advantages over other direct printing methodologies. Such advantages include that AIP does not need small nozzles and ejection orifices that have caused many of the reliability and picture element or pixel placement accuracy problems which conventional drop-on-demand and continuous-stream ink jet printers have experienced. Since AIP avoids the clogging and manufacturing problems associated with drop-on-demand, nozzle-based ink jet printing, it represents a promising direct marking technology. More detailed descriptions of the AIP process can be found in U.S. Pat. Nos. 4,308,547, 4,697,195, 4,801,953, 5,028,937, 5,229,793, 5,231,426 6,048,050, 6,200,491 and 6,217,151, all of which are incorporated herein by reference in their entirety. With AIP, bursts of focused acoustic energy emit droplets from the free surface of a liquid onto a recording medium. By controlling the emitting process as the recording medium moves relative to droplet emission sites, or as the droplet emission sites move relative to the recording medium, a predetermined image is formed. To be competitive with other printer types, acoustic ink printers need to produce high quality images at low cost. Print heads may be fabricated with a large number of individual droplet emitters using techniques similar to those used in semiconductor fabrication. While specific AIP implementations may vary, and while additional components may be used, each droplet emitter may include an ultrasonic transducer (attached to one surface of a body), a varactor for switching the droplet emitter on and off, an acoustic lens (at the opposite side of the body), and a cavity holding ink such that the ink's free surface is near the acoustic focal area of the acoustic lens. The individual droplet emitter is possible by selection of its associated row and column. Acoustic ink printing is subject to a number of manufacturing variables, including transducer piezo-electric material thickness, stress and composition variation; transducer loading effects due to wire bond attachment to the top electrode and top electrode thickness; ink channel gap control impacting acoustic wave focal point variations; aperture hole variations causing the improper pinning of the ink meniscus; RF distribution non-uniformity along the row electrodes, electromagnetic reflections on the transmission lines, variations in acoustic coupling efficiencies, and variations in the components associated with each transducer. Because of manufacturing constraints and where these variables cannot be sufficiently controlled, the variables can result in nonuniform print profiles. Acoustic ink printing requires precise positioning of the lenses with respect to each other on very closely spaced centers and precise positioning of the lenses with respect to the ink's free surface. The lenses may be chemically etched, molded or cast into materials or substrates such as alumina, silicon nitride and silicon carbide through the use of hot press or injection molding processes or otherwise. Accordingly, there is a desire to provide a print head design and manufacturing process where such arrays can be reliably and consistently manufactured to tight tolerances in large numbers and for reasonable cost.

### SUMMARY OF THE INVENTION

In accordance with one embodiment of the present invention, an ink printing acoustic print head is provided. The ink printing acoustic print head is adapted to print ink on a print medium. The ink printing acoustic print head has a fluid distribution manifold and a fluid distribution stack in fluid communication with the fluid distribution manifold. A front membrane is provided having a print work area. The print work area provides an array of apertures that contain the fluid free surface. The front membrane is sealed to the fluid distribution stack. An acoustic array having droplet emitters is provided. The acoustic array is fixedly located between the front membrane and the fluid distribution stack with the droplet emitters facing the print work area. Ink is transferred from the fluid distribution manifold through the fluid distribution stack and to the print work area. Droplets of ink are emitted from the print work area by selectively energizing the droplet emitters.

In accordance with another embodiment of the present invention, an ink printing acoustic ink print head is provided. The ink printing acoustic ink print head has a fluid distribution housing having a print work area. An acoustic array having droplet emitters is provided. The acoustic array is sealed to the fluid distribution housing with the droplet emitters facing the print work area. The fluid distribution housing has at least two different channels. The channels are adapted to distribute ink to at least two opposing sides of the print work area. Ink is transferred through the channels to the print work area. Droplets of ink are emitted from the print work area by selectively energizing the droplet emitters.

In accordance with one method of the present invention, A method of manufacturing an acoustic ink print head is provided having a first step of providing an acoustic array having droplet emitters. A fluid distribution stack and a front membrane having a print work area are then provided. The acoustic array is then fixedly located relative to the front membrane with tooling features on the fluid distribution stack. The acoustic array and the front membrane are then coupled to the fluid distribution stack.

### BRIEF DESCRIPTION OF THE DRAWINGS

The foregoing aspects and other features of the present invention are explained in the following description, taken in connection with the accompanying drawings, wherein:

FIG. 1A is a side view of an acoustic ink print head assembly;

FIG. 1B is an exploded front view of an acoustic ink print head;

FIG. 2A is a top view of a top plate;

FIG. 2B is a top view of a middle plate;

FIG. 2C is a top view of a back plate;

FIG. 3A is a view of stack assemblies on a tooling plate;

FIG. 3B is an inverted top view of a stack assembly;

FIG. 4A is a top view of a bridge plate;

FIG. 4B is a top view of a stack assembly with a bridge plate and printed wiring board;

FIG. 5A is an inverted bottom view of a manifold;

FIG. 5B is an inverted bottom view of a manifold with adhesive;

FIGS. 6A-6B are respectively a detail elevation and bottom view of a manifold datum feature;

FIG. 7A is a top view of an assembly fixture;

FIG. 7B is an isometric view of a top plate barb feature;

FIG. 8 is a front exploded view of a stack to manifold assembly and assembly fixture;

FIG. 8A is a schematic cross sectional view of the stack to transducer plate assembly and another assembly fixture;

FIG. 9 is a bottom view of a print head assembly with spacers;

FIG. 10 is a front view of a print head showing ink flow distribution;

FIG. 11A is a top view of a print head showing ink distribution;

FIG. 11B is a front view of a print head showing ink distribution;

FIG. 11C is a side view of a print head showing ink distribution;

FIG. 11D is a section view of a print head.

### DETAILED DESCRIPTION

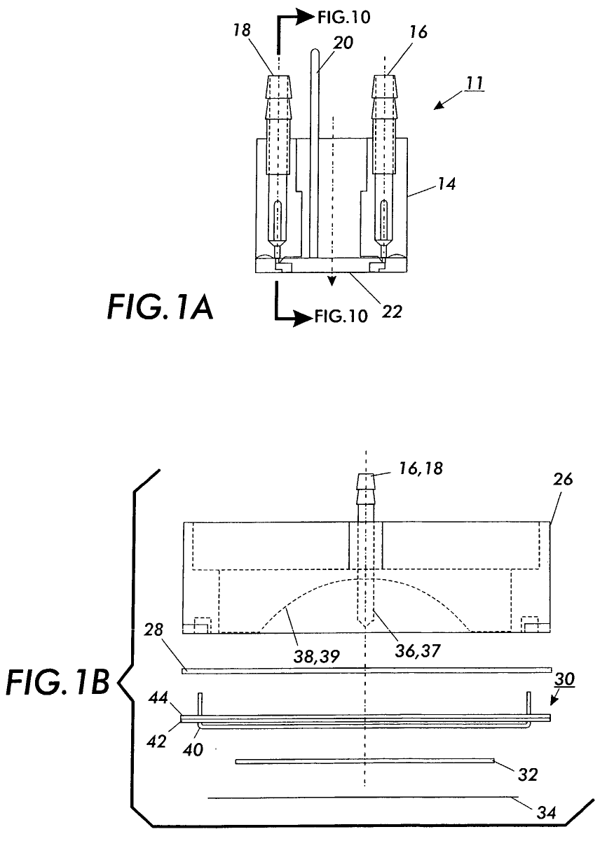

Referring to FIG. 1A, there is shown, a side view of an acoustic ink print head assembly 11 incorporating features of the present invention. Although the present invention will be described with reference to the embodiments shown in the drawings, it should be understood that the present invention can be embodied in many alternate forms of embodiments. In addition, any suitable size, shape or type of elements or materials could be used.

Acoustic ink print head assembly 11 generally comprises housing 14 with ink supply barb 16, ink supply barb 18, electrical control interface 20 and print head work area 22. In order to form a predetermined image, the emitting process is controlled at electrical control interface 20 such that a predetermined droplet emission pattern is emitted from the droplet emission sites of print head work area 22 as the recording medium moves relative to print head 11, or as print head 11 move relative to the recording medium. The description above is merely intended to be exemplary. More or less features could also be provided. For example, any suitable ink supply connection or reservoir could be provided instead of barbs 16 and 18. As a further example, different shape or orientation of the print head work area or otherwise may be provided.

Referring to FIG. 1B, there is shown, an exploded front view of an acoustic ink print head assembly 11 incorporating features of the present invention. Acoustic ink print head assembly 11 generally comprises a manifold 26, bridge 28, stack assembly 30, substrate or acoustic array 32 and front plate, membrane or LLC 34. Manifold 26 is disposed in housing 14 and has passages 36, 38 (shown in dotted line) that allow ink to flow through manifold 26 from barbs 16, 18. Bridge plate 28 provides a mounting interface for interconnect 20 such that interconnect 20 may be electrically or otherwise connected to substrate or acoustic array 32. Stack 30 locates substrate 32 and LLC 34 relative to each other in addition to providing a fluid path from passages 36, 38 to substrate 32 and LLC 34. Stack assembly 30 has top plate 40, middle plate 42 and back plate 44. The description above is merely intended to be exemplary. More or less features could also be provided. For example, more or less plates, paths or different sized components may be provided.

Referring now also to FIG'S. 2A, 2B and 2C, there is shown top views of top plate 40, middle plate 42 and back plate 44. The sheet metal stack 30 consists of plates 40, 42 and 44 which are manufactured as a sheet metal laminate which is readily adaptable to form reentrant structures such as fluid passages, etc. Fine blanking, precision punching, or chemical milling can produce inexpensive parts with high quality which may be bonded together to make such structures. In alternate embodiments, other suitable materials or manufacturing operations may be used such as with molded polymers or otherwise. External features on these structures can be used to provide datum edges that may, for example, locate the structure to other parts of the print head, locate the parts in automated production tooling, locate the print heads in the final product or otherwise. Stack assembly 30 (see FIG. 1B) may be a brazed stack where only middle plate 42 needs to be plated with brazing material. Top plate 40, middle plate 42 and back plate 44 made be made from materials with the same or similar coefficients of thermal expansion. In alternate embodiments, more or less plates may be provided or alternative manufacturing processes may be employed such as utilizing adhesives or utilizing one piece molding or casting processes. In alternate embodiments, materials such as plastics, ceramics, composites or other suitable materials may be used.

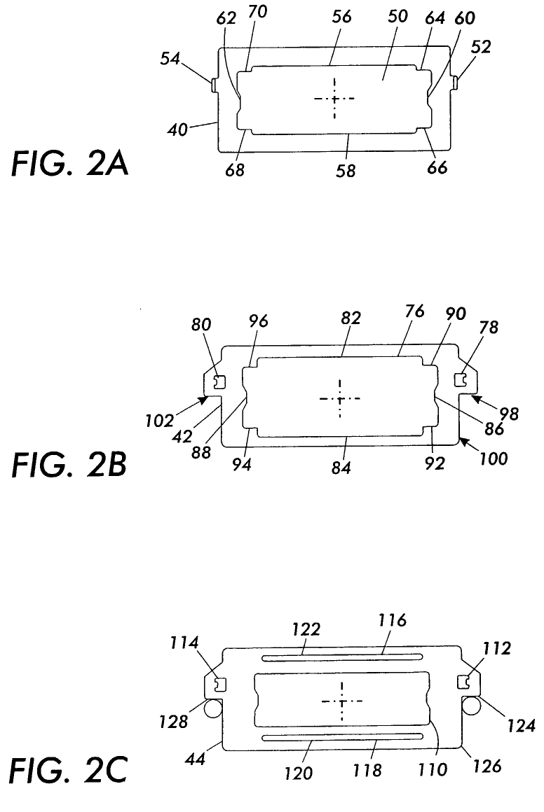

Referring now to FIG. 2A, there is shown a top view of top plate 40. Top plate 40 has opening 50 and barbs 52 and 54. Opening 50 has passages 56 and 58 and locating surfaces 60, 62, 64, 66, 68 and 70.

Referring now to FIG. 2B, there is shown a top view of middle plate 42. Middle plate 42 has opening 76 and openings 78 and 80. Opening 76 has passages 82 and 84 and locating surfaces 86, 88, 90, 92, 94, and 96. Recessed surfaces 98, 100 and 102 are also provided.

Referring now to FIG. 2C, there is shown a top view of back plate 44. Back plate 44 has opening 110 and openings 112 and 114. Back plate 44 has passages 116, 118, 120 and 122 locating datum surfaces 124, 126 and 128 are also provided. In the embodiment shown, locating datum surfaces 124, 126 and 128 are provided on back plate 44 such that these datum surfaces provided for drop in installation of stack 30 (see FIG. 1B) in a printer carriage. In alternate embodiments, more or less datum surfaces may be provided in alternate locations on the parts or on alternate parts. In alternate embodiments, datum surfaces may also be used for tooling. When stack 30, shown in FIG. 1B, is assembled, recessed surfaces 98, 100 and 102 of middle plate 42 are recessed sufficiently to ensure that datum surfaces 124, 126 and 128 can contact tooling or locating features.

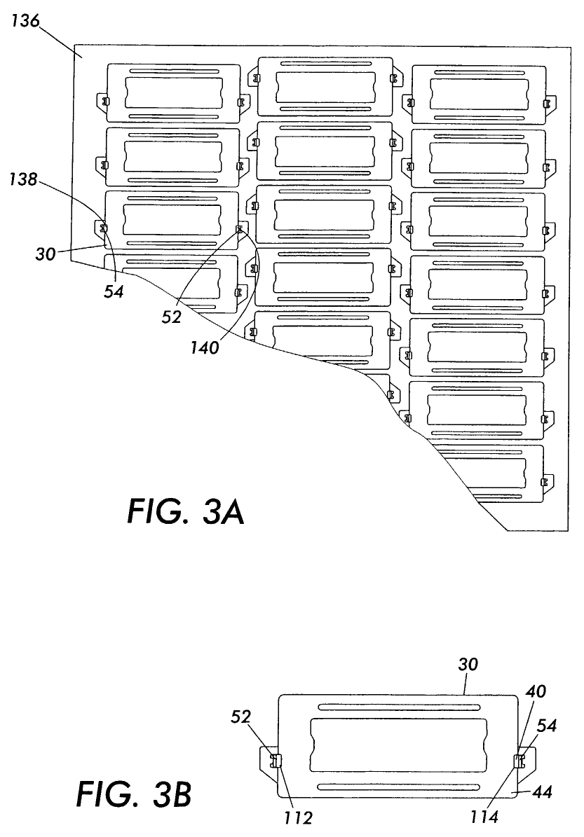

Referring now to FIG. 3B is an inverted top view of the stack assembly 30. As noted before, the sheet metal stack 30 consists of plates 40, 42 and 44. Stack assembly 30 may be a brazed stack where only middle plate 42 (see FIG. 2B) may be plated with brazing material. The tabs 52, 54 in conjunction with the slots or openings 112, 114 (and 78, 80 see FIG. 2B) provides for ease of assembly and repeatable location of plates 40, 42 and 44 relative to each other. Additionally, plates 40, 42 and 44 may be symmetrical as shown such that the parts may be assembled in a failsafe manner. The tabs 52, 54 in conjunction with the slots or openings 112, 114 (and 78, 80 on plate 42) also provides for self tooling of stack 30 in the brazing process such that the location of plates 40, 42 and 44 are held in position relative to each other during brazing of the laminated stack. Top plate 40, middle plate 42 and back plate 44 may be made from materials with the same or similar coefficients of thermal expansion. When the stack 30 is heated for brazing, the tab and opening or slot design allows the stack 30 to expand or contract on its own without interference of any external tooling.

Referring now to FIG. 3A there is shown a view of stack assembly 30 along with an array of stack assemblies similar to stack assembly 30 on a tooling plate. Tooling plate 136 may be used for a process such as brazing of stack 30 or a plurality of such stacks. Tooling plate 136 may have holes 138, 140 such that stack 30 is located by tabs 52, 54 (projecting down in FIG. 3A) in holes 140, 138 respectively. Holes 138, 140 may be over sized relative to tabs 52, 54 allowing for free expansion or contraction of stack 30 during the brazing process. Tooling plate 136 may be fabricated out of high temperature material such as graphite or ceramic and can be drilled and ground flat providing for easy loading and providing for flat assemblies during and after the brazing process. Tooling plate 136 may be fabricated out of a material that has a different coefficient of thermal expansion than top plate 40, middle plate 42 or back plate 44 to prevent tool bonding. In alternate embodiments, stack 30 may be assembled with adhesives instead of by brazing.

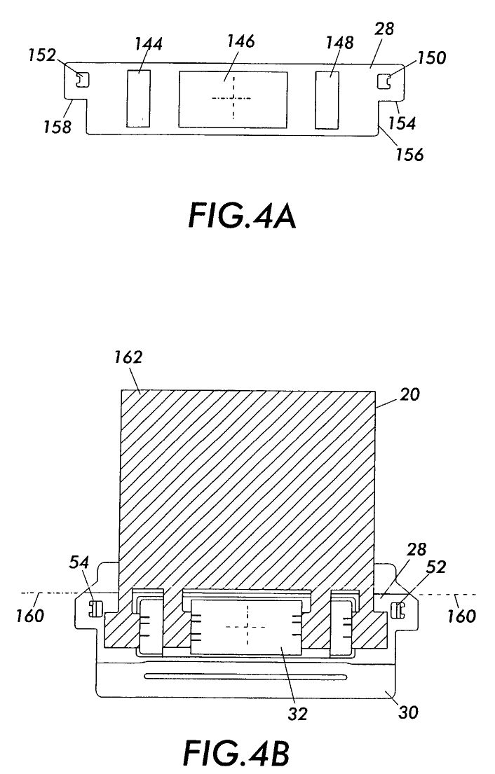

Referring now to FIG. 4A there is shown a top view of bridge plate 28. Bridge plate 28 has openings 144, 146 and 148 and slots or openings 150 and 152. Recessed surfaces 154, 156 and 158 are also provided. The bridge plate 28 supports the electrical interface between the glass or substrate or acoustic array 32 (see FIG. 1B) and other electrical components located in the manifold body or attached to the or part of the print head.

Referring now to FIG. 4B there is shown a top view of stack assembly 30 with bridge plate 28, glass or substrate or acoustic array 32 and interconnect 20 assembled. Circuit board or interconnect 20 is mounted to bridge plate 28 by bonding or otherwise. Bridge plate 28 may be bonded with adhesive or otherwise to stack 30 locating on tabs 52, 54 as shown. Interconnect 20 may be electrically or otherwise connected to glass or substrate or acoustic array 32 by wire bonding or otherwise. End 162 of circuit board 20 may be bent ninety degrees out of the page about axis 160-160 such that the assembly may be coupled to manifold 26 (see FIG. 1B).

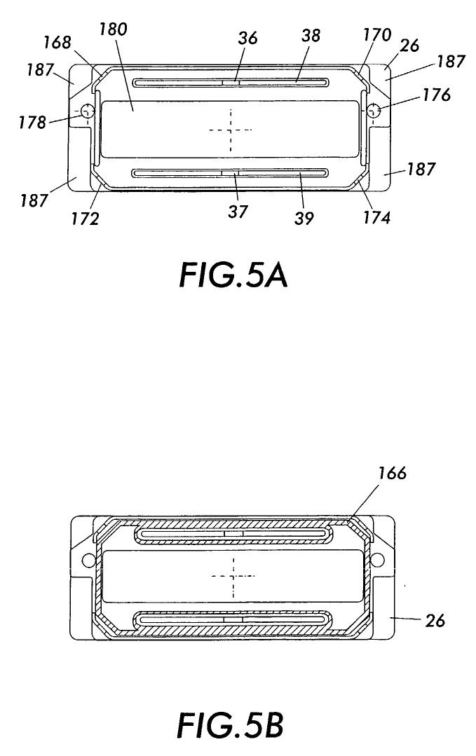

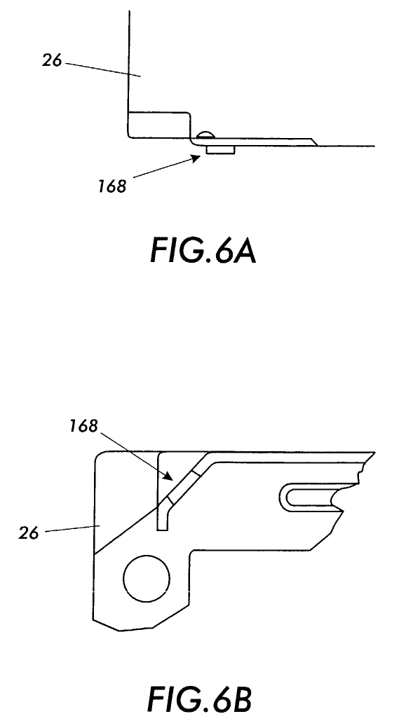

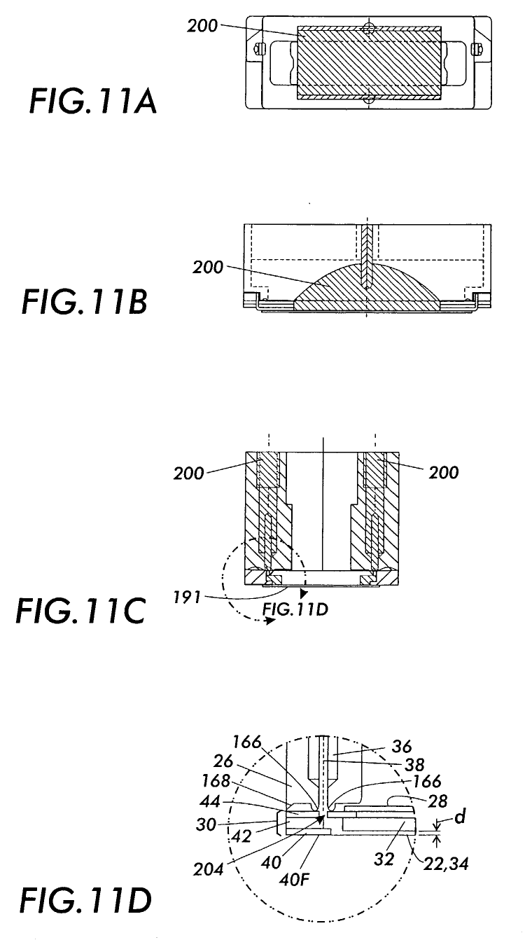

Referring now to FIG. 5A there is shown an inverted bottom view of manifold 26. Referring also to FIG. 5B there is shown an inverted bottom view of manifold 26 with adhesive 166 dispensed thereon. Manifold 26 has passages 36, 38 and 37, 39 (see FIG. 1B) that allow ink to flow through manifold 26 from barbs 16, 18 (not shown) to stack assembly 30 (not shown). Protruding datum features 168, 170, 172 and 174 may be provided in conjunction with holes 176, 178 to allow location of stack assembly 30 relative to manifold 26. The protruding datum features may be substantially similar to each other. Protruding datum features 168, 170, 172 and 174 may be pressed against the stack 30 during the assembly process. Prior to assembly of stack 30 to manifold 26, adhesive 166 may be dispensed as shown in FIG. 5B on manifold 26 in order to further enable fastening of stack 30 to manifold 26 and/or sealing of stack 30 to manifold 26 such that passages 38 and 39 may be in fluid communication with openings or passages of stack 30 to allow ink flow (see FIG. 11B). Adhesive 166 may be dispensed by robotic means or otherwise using a thixotropic adhesive or other suitable adhesive. Adhesive 166 may become the fluid seal between the manifold 26 and stack 30. In alternate embodiments, other suitable methods of fastening or sealing may be provided. Holes 176, 178 may be provided to allow tabs or barbs 16, 18 to be fastened to manifold 26 by ultrasonic welding or other suitable means. The stack/bridge plate assembly is placed in tooling with the circuit board 20 bent up ninety degrees as previously described in order to pass through opening 180 through manifold 26 upon assembly. The manifold is then placed in the tooling and ultrasonics or other suitable fastening and locating means may be used to drive the parts together as well as define additional datum surfaces 187 (see FIG. 5A) as will be described further below.

Referring now to FIG'S. 6A and 6B there is shown respectively a detail elevation and bottom view of a manifold datum feature 168 on manifold 26.

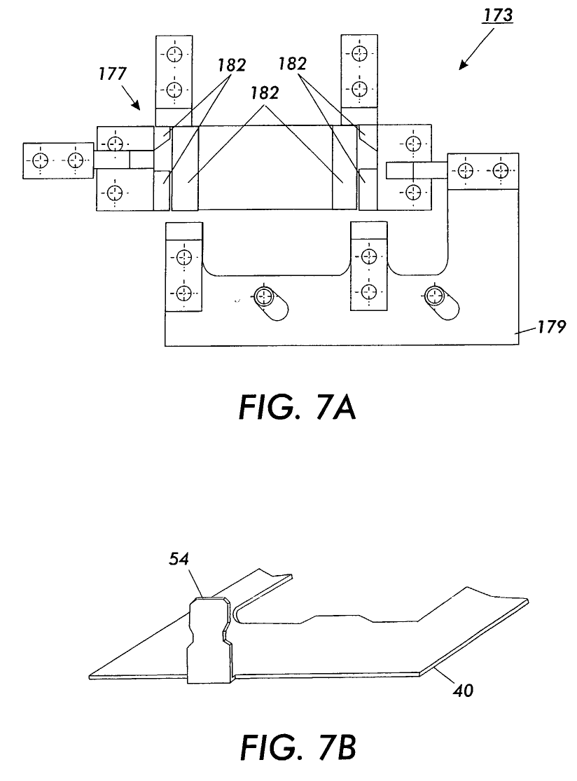

Referring now to FIG. 7A there is shown a top view of an assembly fixture 173. Assembly fixture 173 is adapted to accept the print head prior to ultrasonic deformation. Assembly fixture 173 has a fixed nest 177 and a moveable portion 179 that allows part loading. Assembly fixture 173 additionally has datum surfaces 180 and 182. Datum surfaces 180 and 182 are provided to generate datum surfaces 187 on the print head as will be described further below (such as due to ultrasonic deformation of datum features 168, 170, 172, 174 and of holes 176, 178) to provide precise print head to print head uniformity.

Referring now to FIG. 7B, there is shown an isometric view of top plate 40 having a top plate barb feature 54 with protrusions, barbs or serrations as shown. The top plate barb feature 54 may be designed for interference fit into the respective holes 176, 178 of manifold 26 (see FIG. 5A).

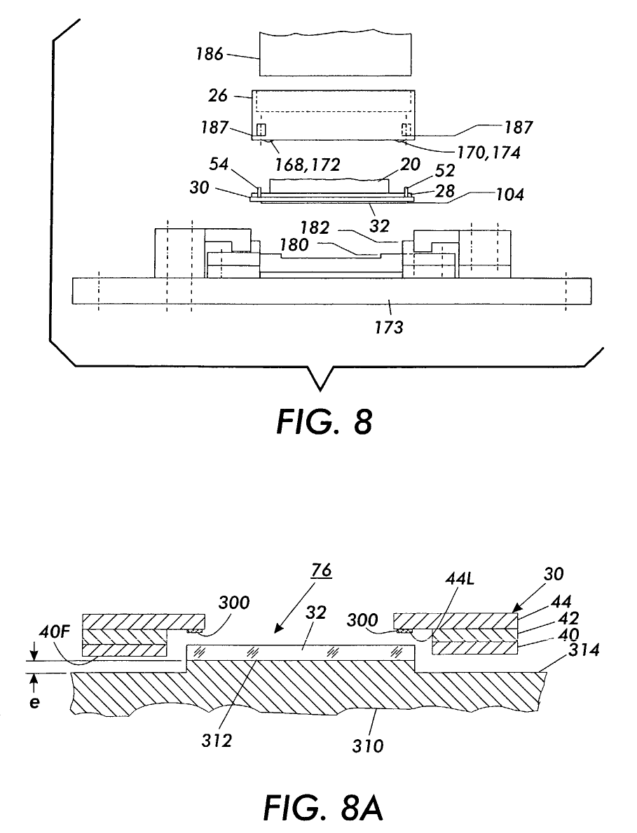

Referring now to FIG. 8, there is shown a front exploded view of a stack to manifold assembly with ultrasonic horn 186 and assembly fixture 173 used to show the ultrasonic assembly process. The forward assembly 30, 28, 20, 32 is placed in the assembly fixture 173 with reference feature or surface 184 against datum 180 and the barbs 52, 54 facing up. The molded manifold 26 is placed in the fixture with interference fit holes 176, 178 engaging over tabs 52, 54. The ultrasonic horn 186 moves down capturing the tabs 52, 54 in holes 176, 178, melting the interference material in the holes around the barbed feature, and melting the protruding datum points 168, 172, 170 and 174 (see FIG. 5A) against the stack 30 until reference feature or surface 187-187 rests against datum 182 of the nest. Alternately, hot plate, pin point, or other forms of plastic heating, joining or otherwise may be used as alternatives to the ultrasonic process. In this manner, precise location of features on the manifold or otherwise may be provided relative to the front face of the print head assembly, even where part thickness variations, such as in the stack 30, are to be accommodated. In this manner, secondary operations, such as costly grinding or machining, are avoided. In this manner, datum surfaces on the print head are provided to allow precise print head to print head uniformity. Print head to print head uniformity may be important where multiple image on image print heads are used, for example, in a printer cartridge with multiple colors where color to color alignment of ink drops is critical. The process described herein may be adapted for automated assembly and may be adaptable to any CRU or module that requires precision alignment.

Referring now to FIG. 8A, there is shown a schematic cross-sectional view of the stack assembly 30 to glass plate 32 (transducer array) assembly and another assembly fixture 310. Assembly fixture 310 may be included as part of fixture 173 (see FIG. 7) or may be an independent fixture as desired. As seen in FIG. 8A, assembly fixture 310 generally has first reference surface 314 and a second reference surface 312. Reference surfaces 314, 312 of fixture 310 are displaced from each other by an offset e. Reference surfaces 312, 314 are formed by any suitable means, such as by machining or precision molding for example, to provide a precise offset e. Offset e is established so that the desired gap d (shown in FIG. 11D) is established upon mounting of the LLC 334 to the acoustic ink print head assembly as will be described in greater detail below. As seen in FIG. 8A, during mounting of the glass plate 32 to the stack assembly 30, the stack assembly may be positioned onto fixture 310 so that front surface/datum 40F is seated on reference surface 314. The glass plate 32 is rested on reference surface 312 of the fixture 310. FIG. 8A shows the glass plate 32 being mounted to the stack 30 before the stack 30 and manifold 26 are coupled to each other (as described previously) for example purposes only. In alternate embodiments, the glass plate may be coupled to the stack after mating the stack to the manifold.

A bead of suitable adhesive 300 is dispensed into the stack assy 30, specifically onto the inside surface 44L of the backplate 44. The transducer/glass 32 is placed by means of fixture into the cavity of the stack assembly 30 and seated against surface 44L. Fiducials may be provided on surface 44L to aid locating the glass plate 32 in the stack assembly cavity and ensure the transducer is disposed accurately with the work area of the print head. The adhesive can be cured in place by various methods, or tacked in place with a secondary adhesive such as UV cure with a post cure (batch) of the main adhesive. The adhesive absorbs tolerance variations between stack assembly 30 and glass plate 32, and provides a solid bed for mounting and ink sealing.

In order to mount the LLC 34 to the stack assembly 30 a very light coating of adhesive is applied to the outside surface 40F of stack assembly 30, by means of adhesive transfer or other precise application. This adhesive layer is thin, possibly a few microns, and may be of a thermosetting type formulation. The adhesive may dry to the touch after application, but is not yet cured. The LLC 34 (see FIG. 11D) is brought into contact using a fixture (not shown) that allows for alignment. The apertures or fiducials (not shown) of LLC 34 are aligned to the lenses of glass plate 32 prior to or after contact depending on the actual techniques employed. Machine vision or manual guidance may be used to provide the position feedback as desired. Once satisfactory alignment and contact is made, time, temperature and/or secondary tacking can be employed to immobilize the parts, join them together and form a seal for ink to flow within during operation.

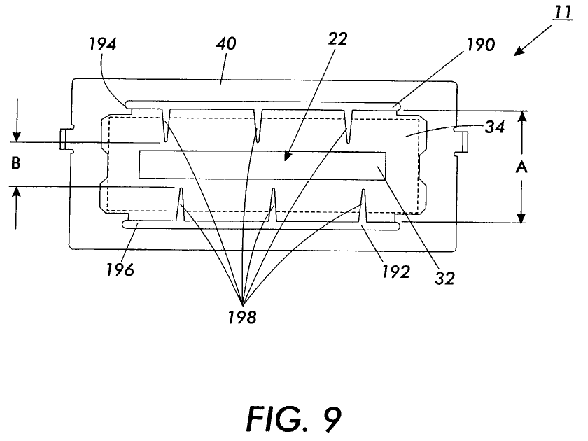

Referring now to FIG. 9, there is shown a bottom view of a print head assembly 11 with spacers. The dimension d between the LLC 34 and the substrate 32 (shown in FIG. 11D for example) must be held tightly in order to have effective use of the work area 22 of the print head 11. Holding this gap tightly is difficult as ink in the gap is at negative pressure which may cause the LLC 34 to bow. Such bowing may degrade the quality of the print output. The amount of bow will vary with pressure, material thickness, material property, gap, and other manufacturing variables making it difficult to control. Precision spacers or combs 190, 192 may be added to control the gap between LLC or membrane 34 and the substrate 32 before LLC 34 is fastened to front plate 40 by adhesives or as part of the ultrasonic bonding process or otherwise. With this distance tolerance controlled, the complexity of related hardware may be simplified resulting in a reduction of cost. Spacers or combs 190, 192 may be retained in features 194, 196 or otherwise retained or fastened to the assembly. Spacers or combs 190, 192 may have fingers 198 that are staggered in order to prevent fluid flow or pressure loss anywhere in the work area of the print head. Spacers or combs 190, 192 may be precision molded from plastic or other suitable material or otherwise manufactured from suitable materials. By way of example, in the embodiment shown, the open span for membrane deflection is reduced from unsupported distance A (such as for example, about 0.770 inches) to unsupported distance B (such as for example, about 0.312 inches) in order to reduce the deflection of membrane or LLC 34. In alternate embodiments, other unsupported distances may be provided.

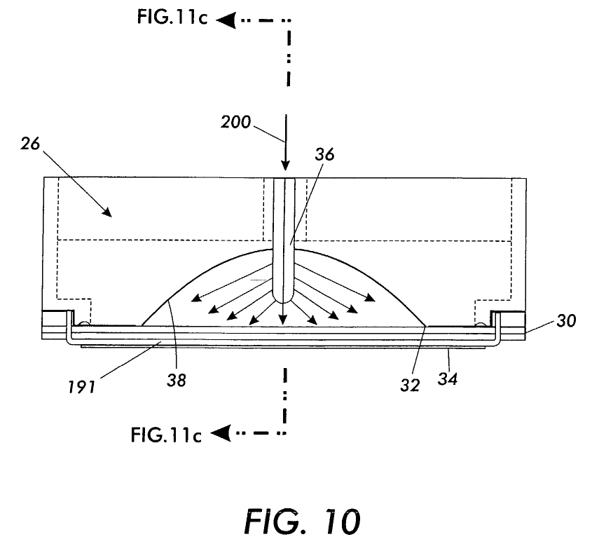

Referring now to FIG. 10 there is shown a front section view of a print head showing a nozzle effect at the hole to slot interface. Manifold 26 has fluid intake hole 36 drilled or otherwise molded in order to intersect a narrow radiused slot 38 in the manifold. This provides a bi-directional nozzle which allows a smooth transition of the ink or fluid 200 from a round to a wide flat fan shaped plenum in order to smoothly transition into the openings or slots 116, 118, 120 and 122 in the stack 30 (see FIG. 2C). The radiused shaped plenum 38 delivers a smooth flow of ink over the entire length of the printing area and also preventing potential for air entrapment. This aids in priming the head assembly with ink. By way of example, in the embodiment shown, a first time flow through of ink may be six seconds or less with bubbles purged. Attached to the plenum is a front piece ink delivery area 191 formed by the interface between the plenum 38 of manifold 26 to stack 30, LLC 34 and substrate 32 (see FIG. 11C also).

Referring now to FIG. 11A, there is a top view of a print head showing ink distribution. Referring also to FIG. 11B is a front view of a print head showing ink distribution. Referring also to FIG. 11C is a side section view of a print head showing ink distribution. Referring also to FIG. 11D is a enlarged section view of a print head showing the assembly. A secondary narrowing or constriction of the ink flow path as shown at 204 is provided after the ink delivery area. This narrowing or constriction is desirable to spread ink out and limit the fluid volume, equalize pressure, and enhance the uniformity of the ink flow over each nozzle. The secondary narrowing or constriction of the ink flow path as shown at 204 is formed as part of stack 30 where the passages 122, 116, 120, 118 of back plate 44 are offset from the passages 82 and 84 of middle plate 42. In this manner, the re-entrant features of stack 30 are provided by simply narrowing a dimension in the middle plate 42.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. An ink printing acoustic print head adapted to print ink on a print medium, the ink printing acoustic print head comprising:
a fluid distribution manifold;
a fluid distribution stack in fluid communication with the fluid distribution manifold;
a front membrane having a print work area, the front membrane sealed to the fluid distribution stack; and
an acoustic array connected to the fluid distribution stack, the acoustic array being positioned by the fluid distribution stack to form a predetermined gap with the front membrane;
wherein, ink is transferred from the fluid distribution manifold through the fluid distribution stack to the predetermined gap for the acoustic array to generate droplets of ink emitted from the print work area.

2. The ink printing acoustic print head of claim 1 further comprising a spacer mounted between the acoustic array and the front membrane, wherein the spacer fixes a distance between the acoustic array and the front membrane.

3. The ink printing acoustic print head of claim 2 wherein the spacer comprises a plurality of fingers.

4. The ink printing acoustic print head of claim 1 wherein the fluid distribution stack comprises:
a first plate;
a second plate; and
a middle plate, the middle plate coupled to the first plate and the second plate;
wherein, the middle plate, the first plate or the second plate are located relative to each other by a tooling feature located on the middle plate, the first plate or the second plate.

5. The ink printing acoustic print head of claim 4 wherein the front membrane is mounted to the first plate, the first plate having a datum surface to locate the front membrane in a predetermined position relative to the head, and to position the fluid distribution stack relative to a reference surface so that when the acoustic array is mounted to the second plate the predetermined gap with the front membrane is defined.

6. The ink printing acoustic print head of claim 4 wherein the tooling feature comprises a formed tab.

7. The ink printing acoustic print head of claim 6 wherein the formed tab is used to couple the fluid distribution stack to a mating feature in the fluid distribution manifold by ultrasonic deformation.

8. The ink printing acoustic print head of claim 4 wherein the middle plate is coupled to the first plate and the second plate by brazing.

9. The ink printing acoustic print head of claim 1 further comprising:
a bridge plate located between the fluid distribution stack and the fluid distribution manifold; and
an interconnect coupled to the bridge plate, the interconnect electrically coupled to the acoustic array.

10. The ink printing acoustic print head of claim 1 wherein the ink is transferred through at least two different channels of the fluid distribution stack to at least two opposing sides of the print work area.

11. An ink printing acoustic print head comprising:
a fluid distribution housing having a print work area;
an acoustic array having droplet emitters, the acoustic array sealed to the fluid distribution housing, the droplet emitters facing the print work area; and
the fluid distribution housing having at least two different channels, the channels being adapted to distribute ink to at least two opposing sides of the print work area;
wherein, ink is transferred through the channels to the print work area and wherein droplets of ink are emitted from the print work area by selectively energizing the droplet emitters.

12. The ink printing acoustic print head of claim 11 further comprising a spacer coupled to the acoustic array, wherein the spacer fixes the thickness of ink film in the print work area.

13. The ink printing acoustic print head of claim 12 wherein the spacer comprises a plurality of fingers.

14. The ink printing acoustic print head of claim 11 wherein the fluid distribution housing further comprises:
a fluid distribution manifold;
a fluid distribution stack in fluid communication with the fluid distribution manifold; and
a front membrane sealed to the fluid distribution stack.

15. The ink printing acoustic print head of claim 14 wherein the fluid distribution stack comprises:
a top plate;
a back plate; and
a middle plate, the middle plate coupled to the top plate and the back plate;
wherein, the middle plate, the top plate or the back plate are located relative to each other by a tooling feature located on the middle plate, the top plate or the back plate.

16. The ink printing acoustic print head of claim 15 wherein the tooling feature is used to couple the fluid distribution stack to a mating feature in the fluid distribution manifold by ultrasonic deformation.

17. The ink printing acoustic print head of claim 14 further comprising:
a bridge plate located between the distribution stack and the distribution manifold; and
an interconnect coupled to the bridge plate, the interconnect electrically coupled to the acoustic array.

18. A method of manufacturing an acoustic ink print head comprising the steps of:
providing an acoustic array having droplet emitters;
providing a fluid distribution stack;
providing a front membrane having a print work area;
fixedly locating the acoustic array relative to the front membrane with tooling features on the fluid distribution stack; and
coupling the acoustic array and the front membrane to the fluid distribution stack.

19. The method of manufacturing an acoustic ink print head of claim 18 further comprising the step of providing a spacer between the front membrane and the acoustic array.

20. The method of manufacturing an acoustic ink print head of claim 18 further comprising the steps of providing a fluid distribution manifold and coupling the fluid distribution manifold to the fluid distribution stack.

21. The method of manufacturing an acoustic ink print head of claim 20 further comprising the step of locating the fluid distribution manifold to the fluid distribution stack with a tooling feature located on the fluid distribution manifold.

22. The method of claim 18 wherein providing the fluid distribution stack comprises stacking a first plate, a second plate and a third plate to form the fluid distribution stack.

23. The method of claim 22 further comprising aligning the first, second and third plates using tooling features on the first second or third plates.
